(19) United States
(12) Patent Application Publication
(10) Pub. No.: US 2002/0140172 A1
(43) Pub. Date: Oct. 3, 2002

(54) Coupling gasket and installation method

(76) Inventor: Bruce M. Platusich, Warwick, RI (US)

Correspondence Address: MANELLI DENISON & SELTER, 2000 M STREET NW SUITE 700, WASHINGTON, DC, 20036-3307, US

(21) Appl. No.: 09/820,883

(22) Filed: Mar. 30, 2001

(51) Int. Cl. F16L 21/02

(52) U.S. Cl. 277/314

(57) ABSTRACT

An elastomeric sealing gasket for a pipe or other fluid tight coupling is protected from degradation by incorporating a chelating or antioxidant compound in the sealing gasket material during manufacture or applied as a coating after manufacture but before installation in the ground.

### FIELD OF THE INVENTION

This invention relates to improved seals for fluid bearing conduit couplings and, more particularly, to couplings that are buried in soil of various types and chemical constituents. In one embodiment, the seals of this invention are in the form of annular gaskets used with pipes made of synthetic and metallic materials such as polyethylene, polyvinyl chloride, steel, copper, aluminum, stainless steel and like materials.

### BACKGROUND OF THE INVENTION

In fluid distribution systems, many portions of the conduits are typically exposed to compositions that may be detrimental to the seals employed at pipe and valve joints. Such seals are frequently composed of natural rubber or synthetic elastomers such as EPDM or neoprene. It has also been recognized that where metal pipes are used, the metal such as copper or steel in the pipe structure can act as a catalyst causing oxidation of the polymeric compositions used in the gasket seals. In such cases, the seals are subject to degradation over time due to chemical reactions within the pipe material and this can eventually result in seal failure. Also, degradation can result from seepage from the fluid material carried by the conduit system and contact of the seals with such materials used in industrial installations. Such failures require monitoring of the conduit system and replacement of the seals which is a labor intensive and costly operation.

Manufacturers of fluid distribution systems have attempted to lessen the impact of seal degradation by using coupling structures that isolate the seals used from the surrounding pipe metals and, while these have tended to extend the useful life of the seals, the expense increase both in terms of manufacturing and installation has often offset the benefits. Manufacturers have also faced the problem of constructing a system with seals that will be exposed in use to a great variety of significantly different environmental conditions particularly for geographically extensive systems. Thus, a seal that is adapted for one condition may not be successful in another conduit system.

### BRIEF DESCRIPTION OF THE DRAWING

FIG. 1 is schematic side view in elevation of a pipe coupling that can be used with the present invention.

### SUMMARY OF THE INVENTION

The present invention provides a highly efficient solution to the foregoing difficulties in fluid distribution systems by the use of a lubricant for a sealing gasket for conduits which incorporates a chelating antioxidant additive in the lubricant. With this system, no modification of a conduit coupling is required and no added installation work is needed to establish a sealed pipe joint. Moreover, the additive can be inexpensively incorporated in the lubricant and can be readily adapted to the conditions of a particular site.

Preferably, the chelating agent will function as an antioxidant to prevent degradation of the seal due to chemical reaction with the oxidizing chemicals in the conveyed fluid and it will serve to mitigate the propensity for the metal pipe to act as a catalyst. Other types of preservative agents may also be incorporated or carried by the lubricant. In some form of seals, the chelating agent may be incorporated in the lubricant directly by mixing such as at the installation site and its concentration adjusted to compensate for the conditions at the particular site.

### DETAILED THE DESCRIPTION OF THE INVENTION

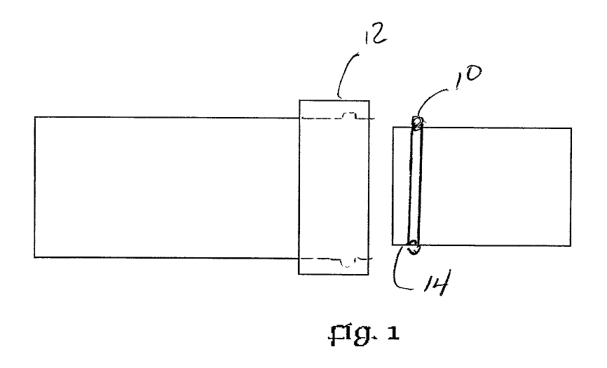

Typically, the elastomeric gaskets are used in pipes systems such as shown in FIG. 1 at 10 where the ends 12 and 14 of the pipes are grooved to receive the gaskets to provide a seal between the pipe ends. As noted above, leakage of such gaskets can cause significant loss to property that is damaged by the leakage and result in costly repairs and replacement in the system. Where the fluid being handled by the pipes systems is dangerous or toxic, injury to persons can also result. It is clearly important, therefore, that degradation of the gaskets be minimized to the greatest extent possible and preferably without significantly altering the cost of the pipe system or the cost of installation of such a system.

While degradation of an elastomeric seal or gasket can be avoided such as by the use of nonmetallic pipes, in many applications, only metal pipes can be employed since both the cost of installation and the durability of metal pipes compel their use in many fluid distribution systems from an economic viewpoint. Indeed, in many water distribution systems the fluid pressure that must be accommodated mandates the use of metal pipes. Typically, the seals and gaskets are made from a variety of polymers. Ethylene propylene diene monomer and halogenated butyl are frequently used.

It has been found that with many elastomers, contact with the metal pipes with or without the complication of ground moisture results in oxidation of the polymer constituting the elastomers with the metal of the pipes acting as a catalyst. This is particularly the case where the conduits are made of copper or steel. According to the invention, the harmful oxidation of the polymer of the gasket is significantly reduced by the incorporation of the chelating agent and anti-oxidants in the surface of the elastomeric gasket. Preferably, this is accomplished by incorporating the antioxidant agents in the lubricants that are used to facilitate the installation of the gasket in the pipe system. Alternatively, the antioxidant agent can be applied as a coating to the gasket itself such as during manufacture of the gasket.

Several antioxidants are commercially available for use in this invention. Preferably, compounds that are stable over long periods should be used and, to this end, a compound that is commercially available under the trademark Naugard XI-1 from Uniroyal Chemical Company has proven useful. Also, another compound is available from the same company and sold under the trademark Aranox. Naugard is described chemically as:

2,2′-Oxamidobis[ethyl-3-(3,5-di-t-butyl-4-hydroxyphenyl)propionate]

and exhibits dual activity as an antioxidant and metal deactivator and is characterized by low volatility and long-term storage stability. It is described by the manufacturer as useful with polyolefins and chlorinated polyethylene as well as other compounds.

Aranox is described chemically as:

N-Phenyl-N′-(p-toluensulfonyl)-p-phenylenediamine and is indicated by the manufacturer for use as an antioxidant with certain polymers of more limited scope than Naugard.

In certain circumstances, the antioxidant may be added directly to the elastomer compound but care must be taken to use only the amount needed to assure a desired level of antioxidant activity. In fabricating elastomers, an antioxidant can stop the curing process when added to the compound prior to completion of the curing. By using the antioxidant in the lubricants that is applied to the gasket when constructing the pipe system and installing the gasket, this difficulty is minimized or avoided. As an alternative, as noted above, the antioxidant compound can be added to the elastomeric gasket as a coating after curing has been completed.

According to the method of the present invention, in a preferred form, the antioxidant is incorporated into a lubricants that is typically used with and the elastomeric gasket, the lubricants as an applied to the gasket or to see pipe or to both and then the tight ends are joined at with the gaskets serving as a seal between the pipe ends. Alternatively, an antioxidant coating is applied to the gasket, a lubricants is that an applied to either the gasket or the pipe ends or both, and the pipe coupling established. In either circumstance, the lubricant is distributed across the interface between the gasket and the metal pipes during assembly.

With use of the invention, the necessity of changing the materials of the pipe system to avoid degradation of the elastomeric gasket is eliminated while permitting use of the less expensive metal pipes that are required to allow the pipe system to handle fluid pressures encountered in many fluid systems.

Having described the invention, it will be apparent to those skilled in this art that modifications thereto may be made that are within the scope of the invention.

What is claimed is:

1. A conduit seal comprising an elastomeric seal element and a lubricant, said lubricant including a chelating agent incorporated therein.

2. The invention as claimed in claim 1 wherein said seal is ethylene propylene diene monomer

3. The invention as claimed in claim 1 halogenated butyl.

4. The invention as claimed in claim 2 wherein said lubricant is non-petroleum based.

5. The invention as claimed in claim in claim 1 wherein said chelating agent is 2,2′--Oxamidobis[ethyl-3-(3,5-di-t-butyl-4-hydroxyphenyl)propionate].

6. The invention as claimed in claim 1 wherein said chelating agent is N-Phenyl-N′-(p-toluensulfonyl)-p-phenylenediamine.

7. A method of installing a pipe coupling comprising the steps of
a) coating a sealing element with a chelating agent,
b) placing the coated sealing element about a pipe end,
c) placing the end of another pipe over the sealing element.

7. The method as claimed in claim 7 including the step of incorporating the chelating agent in a lubricant before coating said sealing element.

8. The method as claimed in claim 7 wherein said chelating agent is 2,2′-Oxamidobis [ethyl-3-(3,5-di-t-butyl-4-hydroxyphenyl)propionate]

9. The method as claimed in claim 7 wherein said chelating agent is N-Phenyl-N′-(p-toluensulfonyl)-p-phenylenediamine.

10. A method of installing a pipe coupling comprising the steps of
a) incorporating an anti-oxidant material in an elastomeric seal element,
b) establishing a pipe coupling with another pipe using said elastomeric seal element.

11. The method as claimed in claim 10 wherein said anti-oxidant is 2,2′-Oxamidobis [ethyl-3-(3,5-di-t-butyl-4-hydroxyphenyl) propionate].

12. The method as claimed in claim 10 wherein said anti-oxidant is N-Phenyl-N′-(p-toluensulfonyl)-p-phenylenediamine.

13. A conduit seal, for a coupling, to which has been applied a coating, in the manufacture of the coupling, that acts as a lubricant and which includes an additive selected from the group consisting of a chelating agent, an anti-oxidant and a combination of a chelating agent and an anti-oxidant.
